(19) United States
(12) Patent Application Publication
(10) Pub. No.: US 2017/0183205 A1
(43) Pub. Date: Jun. 29, 2017

(54) On-Board Modular Hoist

(71) Applicant: Helisar, St. Cyr Au Mont D'Or (FR)

(72) Inventor: David Figoureux, Salon de Provence (FR)

(21) Appl. No.: 15/308,785

(22) PCT Filed: Mar. 20, 2015
(86) PCT No.: PCT/FR2015/050689

§ 371 Date: Nov. 3, 2016

(30) Foreign Application Priority Data
May 6, 2014 (FR) 1454083

(51) Int. Cl. B66D 3/22; H02P 7/06; H02P 27/06; B60K 6/20

(52) U.S. Cl. CPC B66D 3/22; B60K 6/20; H02P 7/06; H02P 27/06; B64C 27/04

(57) ABSTRACT

A modular winch onboard an aircraft includes at least one cable wound onto a drum. The winch includes a basic mechanical assembly intended to be attached to the aircraft. The basic mechanical assembly is capable of receiving, in a removable manner, at least one module for varying at least one of the performance characteristics of the winch.

### FIELD OF THE INVENTION

This invention relates to the art of winches, and more particularly to a modular winch onboard an aircraft. The invention notably finds an advantageous but non-limiting application in helicopter winches.

Modular signifies that the winch consists of a subset of modules. Aircraft signifies any means of transportation capable of traveling in the earth's atmosphere.

### BACKGROUND OF THE INVENTION

To date, several types of winches with various designs are known in the prior art, for performing, for example, helicopter rescue missions or for handling equipment by air. These winches are dedicated to a type of helicopter or a type of mission, and have different structures according to their performance. For example, certain winches have hydraulic, electrical or even pneumatically-powered motors. Thus, these winches can have differing cable unwinding speeds or cable lengths depending upon the performance relating to the mission for which they are designed. Mountain rescues, for example, generally require very long cable lengths especially for being able to winch along walls. Conversely, personnel drop missions onto, for example, wind turbines or vessels do not require such long cable lengths. The same reasoning applies to the ascent and descent cable speeds, and also to the tensile force.

Helicopters are often versatile and are used for different types of missions. For each new winch design, the maximum performance required is implemented in order to satisfy the constraints of the most demanding missions. The most modern winches are therefore the highest-performing. And the higher the performance of a winch, the greater its mass. This fact implies that a helicopter operator equipping their helicopter with a winch, is forced to choose the heaviest winch in order to have the most powerful and therefore the most versatile winch. When the latter is commissioned for a mission requiring shorter cable lengths and lower lifting capacities, it carries an oversized winch together with a cable length and lifting capacity that is often too great. The mass carried is therefore far greater than necessary, with all the disadvantages that this entails, particularly in terms of the impact upon fuel consumption, and hence the operational radius, which may be vital to the mission in question.

### SUMMARY OF THE INVENTION

Thus, the invention aims to provide a modular winch, namely a winch whose performance can be adapted depending upon the mission to be performed. The weight of such a winch will then be appropriate to the performance thereof.

To solve the aforementioned problems, a modular winch on board an aircraft has been developed, comprising at least one cable wound onto a drum. According to the invention, said winch comprises a basic mechanical assembly intended to be attached to the aircraft, designed to receive, in a removable manner, at least one module for varying at least one of the performance characteristics of said winch.

More specifically, the performance characteristics that can be varied are the length of the cable, its diameter, the power of the winch and consequently the winding and unwinding speed of said cable, and the power supply of the winch (1).

For this purpose, the basic mechanical assembly (2), attached to the aircraft, comprises mechanical connection means for mechanically connecting a drive module, which is capable of varying the characteristics relating to power, to a cable module, said cable module being capable of varying the characteristics relating to the cable, and comprising at least one cable, at least one drum around which the cable is to be wound/unwound, and means of rotating said drum designed to be connected to the mechanical connection means.

The value of this invention can be understood, given the modular nature of the essential components of a winch, as being able, due to the implementation of independent modules, to very rapidly modify the performance of said winch as needed.

By means of the implementation of such a cable module, it is possible to modulate at will the characteristics of the cable to load on board, both in terms of length and diameter, depending upon the operation to be performed.

Preferably, the module that is capable of varying those characteristics relating to the power supply, consists of an electronic module that is designed to produce an AC or DC current for the drive module from the electrical power generated by the aircraft.

Preferably, the drive module comprises means of transmitting the rotation of the drive shaft, and said drive shaft is connected to said mechanical connection means of the basic mechanical assembly via said transmission means.

Advantageously, the cable module is electrically connected to the drive module.

Similarly, the electronic module is electrically connected to the mechanical connection means of the basic mechanical assembly.

In one specific embodiment, the mechanical connection means are in the form of a hollow shaft, mounted in such a way as to be free to rotate and intended, on the one hand, to be rotated by the motor of the drive module and, on the other hand, to receive the means of rotation of the drum for driving said means in rotation. The hollow shaft presents, for example, internal splines.

The means of rotation of the drum are in the form of a shaft, intended to engage the hollow shaft of the mechanical connection means, said shaft rotating said drum via transmission means for the winding/unwinding of the cable itself around said drum.

### BRIEF DESCRIPTION OF THE DRAWINGS

Further characteristics and advantages of the invention will become apparent from the description provided below, which is for reference only and is in no way restrictive, with reference to the accompanying figures, in which:

FIG. 1 is a schematic perspective view of an onboard modular winch according to the invention;

FIG. 2 is a schematic view similar to that of FIG. 1, showing the modular winch from another viewing angle;

FIG. 3 is a schematic view similar to that of FIG. 2, wherein part of the winch housing has been removed in order to view the interior of said housing;

FIG. 4 is an exploded schematic perspective view of a modular winch according to the invention;

FIG. 5 is a schematic perspective view of the basic mechanical assembly of the modular winch;

FIG. 6 is a schematic perspective view similar to that of FIG. 5, the basic mechanical assembly being represented from another viewing angle;

FIG. 7 is a schematic perspective view of the cable module;

FIG. 8 is a schematic perspective view similar to that of FIG. 7, the cable module being represented without its protective housing;

FIG. 9 is a schematic perspective view of the drive module transmission means;

FIG. 10 is a schematic perspective view similar to that of FIG. 9, the transmission means being represented from another viewing angle.

### DETAILED DESCRIPTION OF THE INVENTION

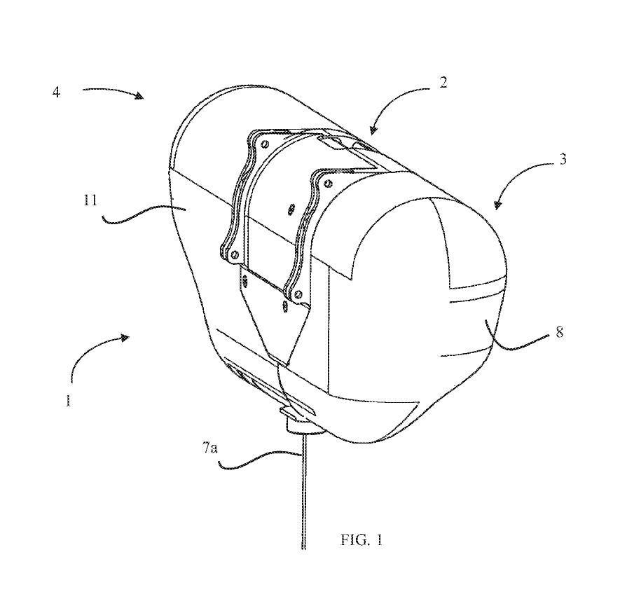

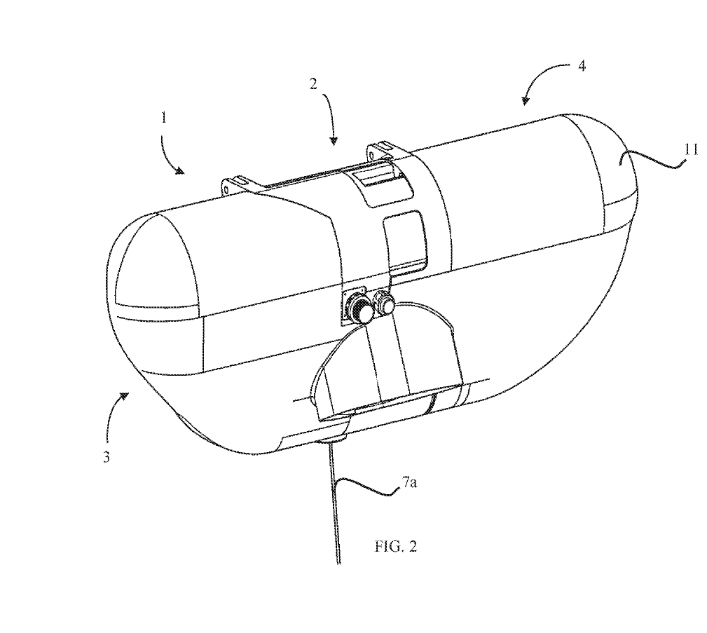

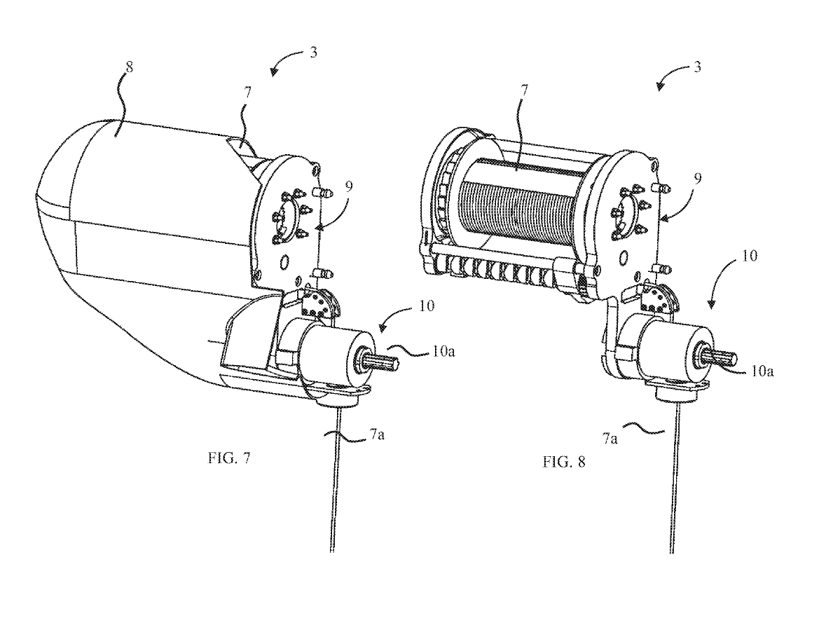

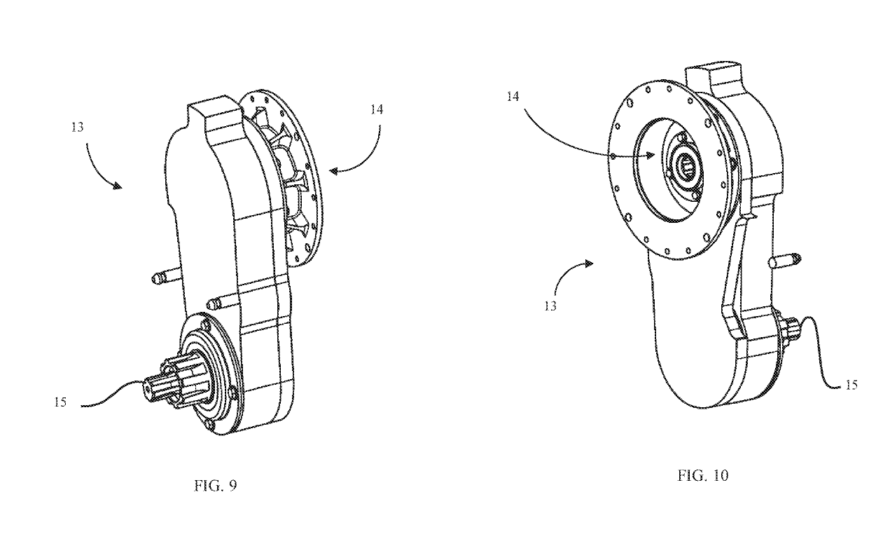

With reference to FIGS. 1 through 10, the modular winch (1) onboard an aircraft according to the invention comprises a basic mechanical assembly (2) intended to be attached to the aircraft and to receive, in a removable manner, a cable module (3), a drive module (4) associated with said cable module, and an electronic module latched to the drive module (4).

The basic mechanical assembly (2) ensures the mechanical (attachment to the aircraft) and electrical (power and control) interfacing between the aircraft and the cable module (3).

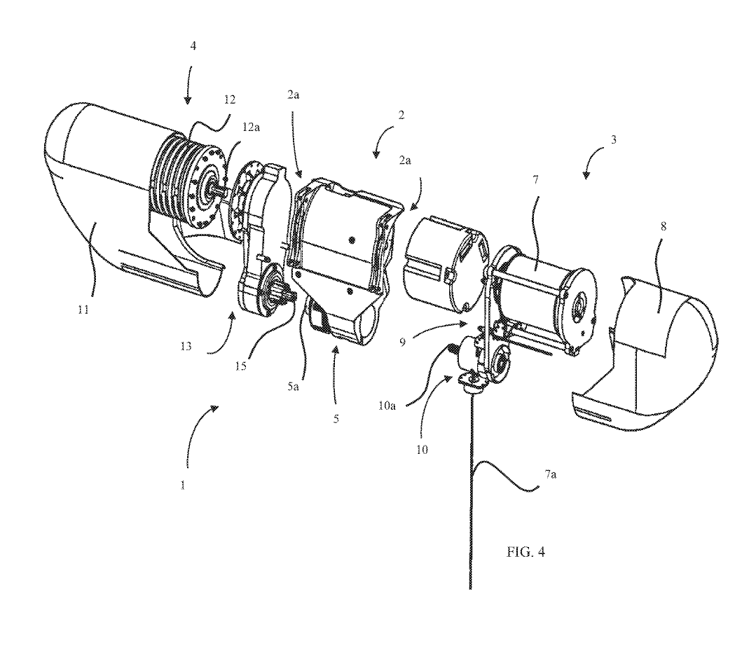

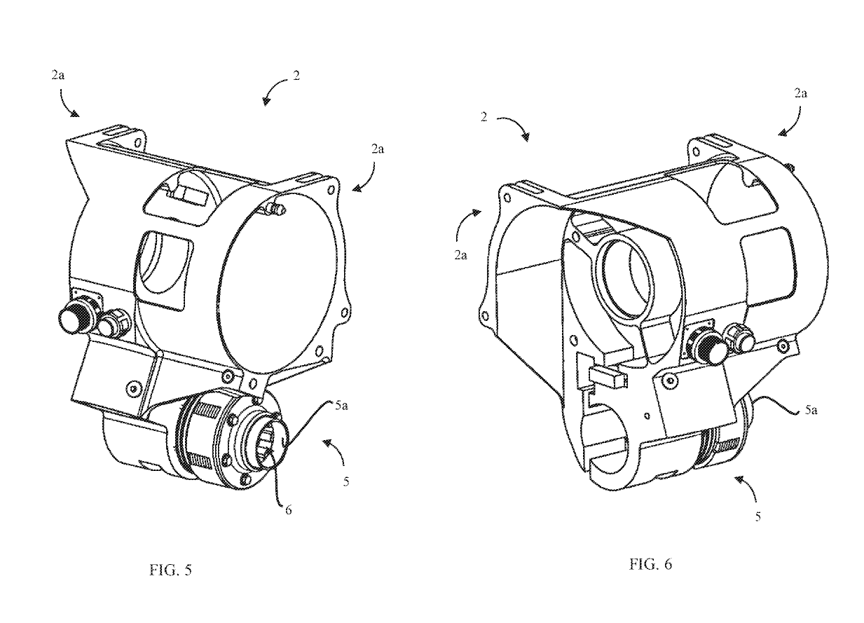

With reference to FIGS. 1 through 6, and more particularly to FIGS. 5 and 6, the basic mechanical assembly (2) forms part of the body of the winch (1) and presents lateral attachments (2a) designed to receive in a removable manner, for example by screwing, the drive module (4) on one side, and the cable module (3) on the other side.

The basic mechanical assembly (2) further comprises mechanical connection means (5) for mechanically connecting the drive module (4) to the cable module (3). The mechanical connection means (5) are arranged on the lower part of the basic mechanical assembly (2) and comprise a hollow shaft (5a) mounted in such a way as to freely rotate. The hollow shaft (5a) has internal splines (6) and is designed to receive a splined shaft that engages on both sides, for transmitting rotation from one to the other.

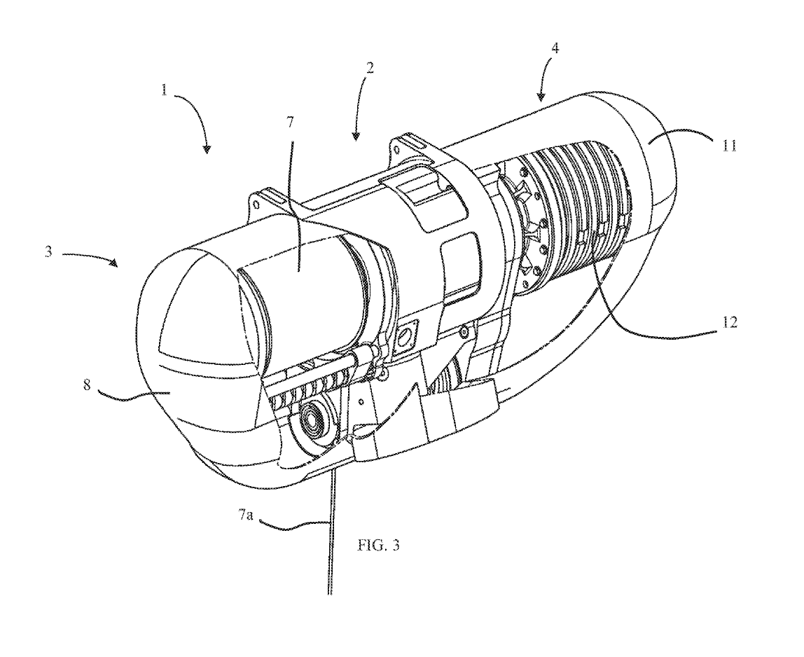

The cable module (3) comprises a drum (7) around which said cable (7a) is stored. The cable module (3) helps vary the characteristics relating to the cable (7a). With reference to FIGS. 3, 4, 7, and 8, the cable module (3) comprises a housing (8) that is designed to be attached in a removable manner to the basic mechanical assembly (2) in order to form part of the body of the modular winch (1).

The housing (8) of the cable module (3) comprises internally and partially above, a drum (7) mounted such as to be able to rotate around its axis of rotation. Said drum (7) is latched, via the transmission means (9), to the rotation means (10) such as to allow the winding of a cable (7a) around said drum (7). These rotation means (10) are in the form of a splined shaft (10a) protruding outwards from the housing (8) of the cable module (3). Said splined shaft (10a) is intended to be inserted into the hollow shaft (5a) of the mechanical connection means (5) of the basic mechanical assembly (2), and to engage the internal splines (6) of said hollow shaft (5a).

The cable (7a) is then attached at one end to the drum (7) and comprises at its free end, a hook and/or a handle (not shown) according to the winching missions to be performed.

The drive cable (4) helps vary the characteristics relating to power. With reference to FIGS. 3 and 4, the drive module (4) comprises a housing (11) that is designed to be attached in a removable manner to the basic mechanical assembly (2) in order to form part of the body of the modular winch (1). This housing (11) contains a motor (12) equipped with a drive shaft (12a). With reference to FIGS. 4, 9, and 10, the drive shaft (12a) is latched to the transmission means (13). These transmission means (13) include, on the one hand, receiving means (14) of the drive shaft and, on the other hand, a splined shaft (15) that is intended to be engaged within the hollow shaft (5) of the mechanical connection means (5) of the basic mechanical assembly (2). The splined shaft (15) is intended to engage the internal splines (6) of said hollow shaft (5A). The transmission means (13) are designed to transmit through gears, belts, or other means, the rotation of the drive shaft (12a) to the splined shaft (15).

The rotation of the motor (12) drives the rotation of the splined shaft (15), which leads to the rotation of the hollow shaft (5a), which drives the rotation of the rotation means (10) of the drum (7), and therefore the rotation of the drum (7) allowing the winding or the unwinding of the cable (7a).

The electronic module helps vary the characteristics relating to the power supply, and can produce an AC or DC current for the drive module from the electrical power generated by the aircraft.

With reference to FIG. 4, the electronic module contains an electronic board for the management of the mechanical connection means (5) and therefore of the motor (12). This board especially comprises electrical connection means that are intended to engage the electrical connection means of said mechanical connection means (5).

These different modules are therefore provided with means of implementing, in an easy manner, a mechanical and/or electrical connection between them, in order to facilitate the choice of the user depending upon the mission to be performed.

As is clear from the foregoing, the invention proposes a modular winch that can be interchanged quickly and easily depending, for example, upon the power of the motor, the length of cable required, etc., especially based upon the winching mission to be performed.

That said, and as mentioned in the introduction, the basic mechanical assembly (2) can integrate the functions of the drive module (4) and the electronic module.

1. A modular winch designed to be onboard an aircraft, said winch including at least one cable wound onto a drum, and comprising a basic mechanical assembly intended to be attached to the aircraft, said basic mechanical assembly being designed to receive, in a removable manner, at least one module for varying at least one of the performance characteristics of said winch, namely the length of the cable, the diameter of the cable, the power of the winch and consequently the winding and unwinding speed of said cable, the power supply of the winch:
wherein the basic mechanical assembly attached to the aircraft comprises a mechanical connection connecting a drive module, which is capable of varying the characteristics relating to the power of the winch, to a cable module; and
wherein the at least one module comprises a cable module, which is capable of varying characteristics relating to the cable, comprising at least one cable, at least one drum around which the cable is adapted to be wound/unwound, and a rotation portion of said drum designed to be connected to the mechanical connection.

2. The onboard modular winch according to claim 1:
wherein the drive module comprises a motor whose drive shaft is designed to be connected to the mechanical connection, and;
wherein said mechanical connection is designed to transmit the rotational movement of the drive shaft to the rotation portion of the drum for the winding/unwinding of said cable.

3. The onboard modular winch according to claim 1, wherein the module capable of varying the characteristics relating to the power supply consists of an electronic module, designed to produce an AC or DC current for the drive module from the electrical power generated by the aircraft.
